(19) United States
(12) Patent Application Publication
(10) Pub. No.: US 2004/0240378 A1
(43) Pub. Date: Dec. 2, 2004

(54) Method of spread space-spectrum multiple access

(76) Inventors: Benjamin Koon Kei Ng, Mississauga (CA); Elvino Silveira Medina de Sousa, Toronto (CA)

Correspondence Address: DOWELL & DOWELL PC, 2111 Eisenhower Ave., Suite 406, Alexandria, VA, 22314, US

(21) Appl. No.: 10/800,034

(22) Filed: Mar. 15, 2004

Related U.S. Application Data
(60) Provisional application No. 60/454,352, filed on Mar. 14, 2003.

(51) Int. Cl. H04J 11/00

(52) U.S. Cl. 370/206

(57) ABSTRACT

The present invention provides a new multiple access scheme, called the spread space spectrum multiple access scheme (SSSMA), designed for the forward link in a wireless multi-antenna system serving multiple users, who may have different quality of service requirements such as data rate and error probability. In the multi-antenna system where the SSSMA is employed, the base station transmitter and the receivers at the users' terminals all employ multiple antenna elements. By exploiting the multiple antennas which are deployed at the base station and each user's terminal, the objectives of the SSSMA are two folds: (1) increase the number of user-channels available in the system, (2) increase the individual user's data rate and improve the link performance such that each user's service requirement is satisfied. The invention comprises a modulation scheme that is more generally applicable to a system where a transmitter that is fixed, portable, or even under motion, and is usually referred to as a base station, or access point, transmits a number of information bearing signals simultaneously to a number of terminals in different remote locations that may be fixed or mobile. Such a transmission system is normally referred to as a point-to-multipoint transmission system

### CROSS REFERENCE TO RELATED U.S APPLICATION

CD This patent application relates to, and claims the priority benefit from, U.S. Provisional Patent Application Ser. No. 60/454,352 filed on Mar. 14, 2003, which is incorporated herein by reference in its entirety.

### FIELD OF INVENTION

This invention relates to a multiple access method, called the spread space spectrum multiple access scheme (SSSMA), designed for the forward link in a wireless multi-antenna system serving multiple users, who may have different quality of service requirements such as data rate and error probability. The invention comprises a modulation scheme that is more generally applicable to a system where a transmitter transmits a number of information bearing signals simultaneously to a number of terminals in different remote locations that may be fixed or mobile. Such a transmission system is normally referred to as a point-to-multipoint transmission system.

### BACKGROUND OF THE INVENTION

The design of future wireless communications systems aims at combating the adverse conditions existing in wireless channels while providing greater capacity, e.g. rate of data-flow and number of users, under constraints such as limited transmission power and bandwidth. Recently, multi-antenna systems that utilize antenna arrays at both the transmitter and the receiver (multiple-input-multiple-output, or MIMO systems) are gaining in prominence, due to its remarkable potential to provide a multiple-fold increase in transmission capacity (bits/sec per unit bandwidth) under power and bandwidth constraint. While the previous work concentrated mainly on single-user optimization in the multi-antenna system, this present work takes a new and innovative perspective: multi-user optimization.

Multi-user optimization is very important in a wireless cellular system which serves many users, as users may have different service requirements, such as data rate and error probability. Therefore, it would be very advantageous to provide a bandwidth-efficient space-time multiple access method designed for a multi-user multi-antenna system in the forward link transmission (base station to users' terminals) in order to increase the number of user-channels available in the system, and increase the individual user's data rate and improve the link performance such that each user's service requirement is satisfied.

### SUMMARY OF INVENTION

The present invention provides a bandwidth-efficient space-time multiple access method, namely the spread space-spectrum multiple access (SSSMA). The method is designed for a multi-user multi-antenna system in the forward link transmission (base station to users' terminals). By exploiting the multiple antennas which are deployed at the base station and at each user's terminal, the objectives of the SSSMA are twofold: (1) increase the number of user-channels available in the system, or the number of users that can be served simultaneously, and (2) increase the individual user's data rate and improve the link performance such that each user's service requirement in terms of bit error probability and other quality of service measures is satisfied.

The present invention provides a new multiple access scheme, called the spread space spectrum multiple access scheme (SSSMA), designed for the forward link in a wireless multi-antenna system serving multiple users, who may have different quality of service requirements such as data rate and error probability. In the multi-antenna system where the SSSMA is employed, the base station transmitter and the receivers at the users' terminals all employ multiple antenna elements.

An important component of SSSMA is the multiplexer in which the signals from different users are combined into a high rate stream and transmitted through multiple antenna elements at the base station. A set of multi-rate/equal-rate space-time diagonal (STD) spreading sequences are designed to modulate different users' signal streams that are of different/same data rate. Each user is assigned a unique STD sequence, which modulates one code/information symbol over the spreading period. These STD sequences span across the spreading period over different transmitting antennas.

Signals from the different users are transmitted simultaneously. The signal from each user is transmitted as a sequence of channel code symbols, where each such symbol is a sequence of direct sequence spread spectrum chips. This sequence of chips (block of chips) is sub-divided into a set of sub-blocks, where each sub-block is transmitted sequentially over a different antenna.

Each STD sequence is represented by a matrix, where each column has one non-zero value. Elements along a given row represent the chips transmitted on the antenna corresponding to that row.

The procedure of constructing these STD sequences is as follows, (Let N, G be the number of transmitting antennas and the processing gain, or spreading factor, for the lowest rate user, respectively)

Step 1: Define a set of N broadened space-time diagonals over the space-time grid.

Step 2: For equal-rate transmission, construct a G by G orthogonal sequences matrix. For multi-rate transmission, construct a G by G tree-structured sequences matrix, which consists of orthogonal sequences with different lengths.

Step 3: Distribute the chips of the orthogonal sequences (obtained in step 2) along the broadened space-time diagonal. The distribution must eventually allow each sequence to have access to all transmitting antennas (occur at different time instants over the spreading period). Repeat for all N diagonals (obtained in step 1).

Furthermore, the signals from different users may be allocated different power levels, according to the quality of service (QoS) requirements, such as the error-rate performance, associated with different users. The power level of each user-channel can be adjusted in a flexible manner according to the specific objectives and assumptions required in practice. At any user's receiver, the variations of power levels associated with the respective interferers, who share the MIMO channel with the target user, can be exploited to yield performance gain.

The essence of SSSMA is to allow users to share the broadened data-pipe (offered by the multi-antenna channel) simultaneously over the entire transmission interval. The space domain is exploited directly to increase the number of user-channels, which may have different service requirements such as data rate and error-rate performance.

In one aspect of the invention there is provided a spread space spectrum multiple access method for a forward link in a wireless multi-antenna system serving multiple users, the method comprising the steps of:

multiplexing signals from different users at a base station transmitter having multiple antenna elements, modulating different users' signal streams that are of different/same data rate using a set of multi-rate/equal-rate space-time diagonal (STD) spreading sequences, each user being assigned a unique STD sequence, which modulates one code/information symbol over the spreading period, said STD sequences spanning across the spreading period over different transmitting antennas; and

transmitting the multiplexed signals through the multiple antenna elements at the base station wherein signals from the different users are transmitted simultaneously, a signal from each user being transmitted as a sequence of channel code symbols, where each such symbol is a sequence of direct sequence spread spectrum chips, the sequence of chips (block of chips) is sub-divided into a set of sub-blocks, where each sub-block is transmitted sequentially over a different antenna.

In another aspect of the present invention there is provided a forward link apparatus in a wireless multi-antenna system serving multiple users, comprising:

a base station transmitter with receivers at users' terminals including multiple antenna elements;

multiplexer means for multiplexing signals from different users are combined and transmitted through the multiple antenna elements at the base station,

processing means for producing a set of multi-rate/equal-rate space-time diagonal (STD) spreading sequences for modulating different users' signal streams that are of different/same data rate, each user being assigned a unique STD sequence, which modulates one code/information symbol over the spreading period, said STD sequences spanning across the spreading period over different transmitting antennas; and

wherein signals from the different users are transmitted simultaneously, a signal from each user is transmitted as a sequence of channel code symbols, where each such symbol is a sequence of direct sequence spread spectrum chips, the sequence of chips (block of chips) is sub-divided into a set of sub-blocks, where each sub-block is transmitted sequentially over a different antenna.

### BRIEF DESCRIPTION OF DRAWINGS

The following is a description, by way of example only, of the method of producing tubes in accordance with the present invention, reference being had to the accompanying drawings, in which:

FIG. 1 is a block diagram showing a transmitter structure of SSSMA (Base station) constructed in accordance with the present invention;

FIG. 2 shows examples of space-time diagonals;

FIG. 3 shows tree-structured orthogonal sequences;

FIG. 4 shows an example of multi-rate orthogonal sequences;

FIG. 5 shows simulations results of SSSMA in a LAN environment; and

FIG. 6 shows simulations results of SSSMA in a power-controlled system.

### DETAILED DESCRIPTION OF THE INVENTION

General Structure

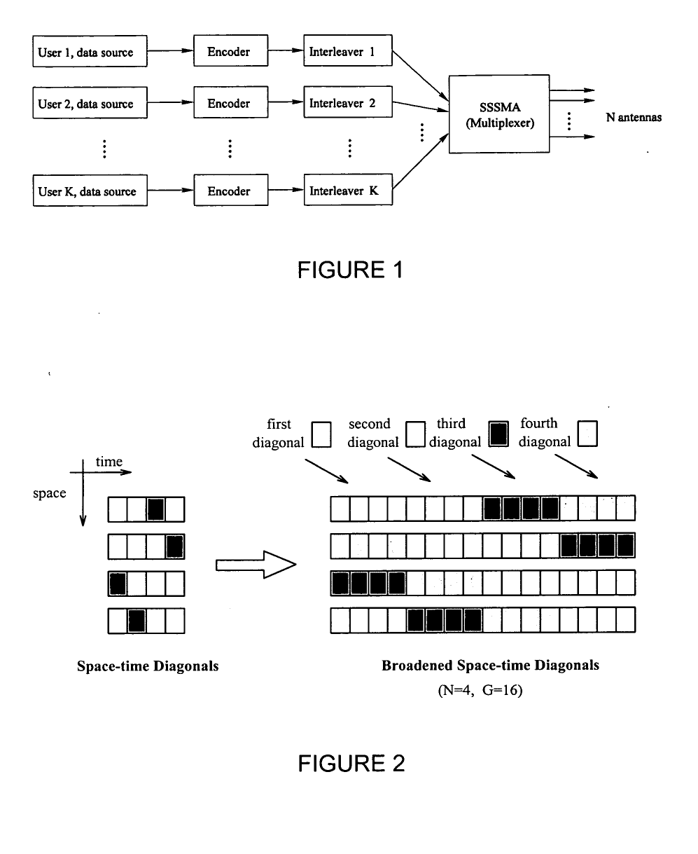

The spread space-spectrum multiple access (SSSMA) scheme is described as follows. FIG. 1 depicts the transmitter (base station) structure of the SSSMA system. There are K independent users, each generates its own digital data input to the system. These independent data streams are encoded using the single-input-single-output (SISO) channel coding scheme. SISO is used to describe a system with only serial-in-time input and only serial-in-time output. The outputs from each encoder are interleaved prior to entering the multiplexer. Each user employs a user-specific SISO interleaver. In the multiplexer, the outputs from the users' interleavers are combined and transmitted through multiple antenna elements. Specifically, there are K output symbols processed at one time, i.e., one output symbol from each interleaver. Each output symbol is modulated with a unique space-time-diagonal (STD) spreading sequence, which essentially allows the input symbol to be transmitted over different antennas and time instants.

In the following, the three main blocks of SSSMA, namely the multiplexer, the channel coding and the interleaver (permutations) are discussed in detail.

The Multiplexer

The principle, upon which the multiplexer is built, is that a set of space-time spreading sequences are employed to separate multiple users' information symbols at full bandwidth-efficiency. This facilitates parallel transmission of multiple users' signals, which may share the MIMO channel at each time instant, over the entire allowable transmission time interval.

With N antennas at the base station, a N×G (where G=kN, for some constant k) spreading matrix for the i^{th} user is defined as follows,

$${S}_{i} = [ \begin{matrix}{s}_{1 , 1}^{i} & {s}_{1 , 2}^{i} & ⋯ & {s}_{1 , G}^{i} \\ {s}_{2 , 1}^{i} & {s}_{2 , 2}^{i} & ⋯ & {s}_{2 , G}^{i} \\ ⋮ & ⋮ & ⋰ & ⋮ \\ {s}_{N , 1}^{i} & {s}_{N , 2}^{i} & ⋯ & {s}_{N , G}^{i}\end{matrix} ] \qquad ( 1 )$$

Thus, the number of time samples (chips) considered within this spreading interval is equal to G. At full bandwidth-efficiency, one may construct a set of distinct N·G spreading sequences (i.e., Si, i=1, . . . , NG), each of them is used to modulate one information symbol of a unique user. Henceforth, it is assumed that the number of users is equal to K=N·G, although such a number may have a different value. A new type of spreading sequence, called the space-time-diagonal (STD) spreading sequence, is proposed. STD sequences can be constructed based on the following procedure,

1. Construct a group of N distinct space-time-diagonal matrices (STDM or φ_{STD,m} m=1,2, . . . ,N) each of which has dimension N×N. The STDMs are defined in the following. First, denote eᵢ as the unit column vector with a unit only at the i^{th} entry and zero otherwise. Let cⱼ^{m} be the j^{th} column of the m^{th} STDM. The following two rules characterize the structure of STDM,

The m^{th} STDM can be expressed as,

Φ_{STD,m}=[c₁^{m}c₂^{m} . . . c_{N}^{m}]=[eᵢeⱼ . . . eₖ], for some i, j, . . . k,

where i j k, and m=1, . . . , N

For any two STDMs, the following condition must be satisfied:

cᵢ^{m}≠cᵢⁿ∀i, m≠n

As the rows and the columns of each STDM represent the space and the time dimension, respectively, the set of non-zero entries in each STDM define a space-time diagonal. N distinct STDMs define a set of N space-time diagonals.

2. For each STDM, construct the corresponding block-STDM (denoted as BSTDM or φ_{BSTD,m} m=1,2, . . . ,N). Each BSTDM has N rows, and each row has N blocks (of size 1×GIN). The following mapping rule is used to build a BSTDM from a STDM,

$$\begin{matrix}{Φ}_{STD , m} ↦ {Φ}_{BSTD , m} \\ 1 ↦ \underbrace{[ 1 \; 1 ⋯ 1}_{G / N} ] \\ 0 ↦ \underbrace{[ 0 \; 0 ⋯ 0}_{G / N} ]\end{matrix} \qquad ( 2 )$$

In order words, each unit entry in the STDM will be replaced a block of 1s, whereas the zero entry in the STDM will be replaced a block of 0s. Thus, the set of non-zero entries in each BSTDM define a broadened space-time diagonal (see FIG. 2 for an illustration).

3. Each BSTDM will be used to produce a number of STD spreading sequences using a G×G orthogonal matrix. There are two modes of operation: equal-rate (users transmit at the same rate) and multi-rate (users transmit at different rates) transmission.

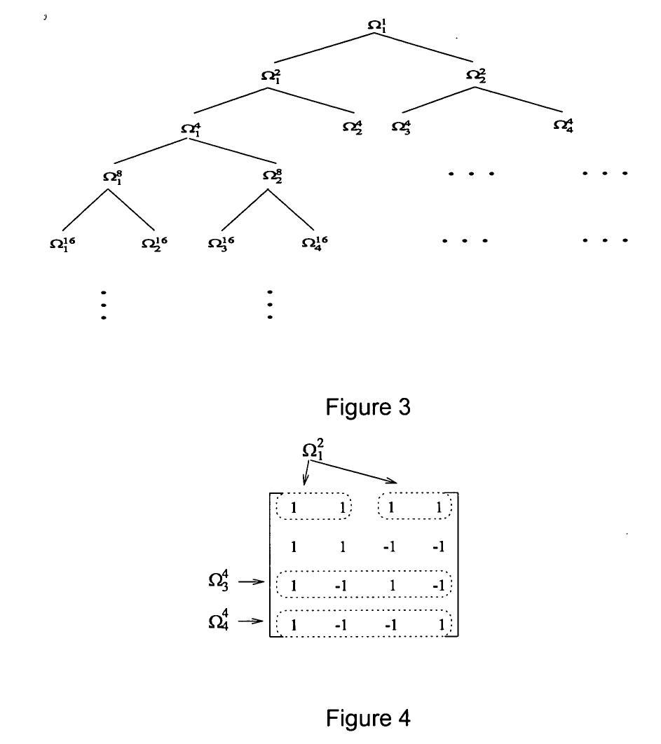

For multi-rate transmission, a G×G tree-structured orthogonal multi-rate matrix Ω is constructed. Let Ωᵢ, and Ω_{i,j} be its i^{th} row and the (i,j)^{th} entry. Ω is constructed iteratively as follows [1],

$$[ \begin{matrix}{Ω}_{1}^{M} \\ {Ω}_{2}^{M} \\ {Ω}_{3}^{M} \\ {Ω}_{4}^{M} \\ ⋮ \\ {Ω}_{M}^{M}\end{matrix} ] = [ \begin{matrix}{Ω}_{1}^{M / 2} & {Ω}_{1}^{M / 2} \\ {Ω}_{1}^{M / 2} & {\overline{Ω}}_{1}^{M / 2} \\ {Ω}_{2}^{M / 2} & {Ω}_{2}^{M / 2} \\ {Ω}_{2}^{M / 2} & {\overline{Ω}}_{2}^{M / 2} \\ & \\ {Ω}_{M / 2}^{M / 2} & {\overline{Ω}}_{M / 2}^{M / 2}\end{matrix} ] \qquad ( 3 )$$

where Ω^{M} is a M×M matrix at the P_{Th} iteration (where P=log₂ M+1), and \overline{(.)} denotes the inverse operation over each element in the row, e.g. (1−1), (−11). One way to start the iterative procedure is to set Ω₁¹=1. Let L be the total number of iterations, G is then equal to 2^{L}. For multi-rate transmission, users using the sequences generated at the P^{th} iteration transmit a data rate which is 2^{L-P} times faster than those using the L^{th} iteration. Define the parent sequence as the sequence which generates the subsequent (children) sequences through the iterative procedure (e.g. in FIG. 3, Ω₁⁴ is the parent sequence for Ω₁⁸, Ω₂⁸, Ω₁¹⁶, Ω₂¹⁶, Ω₃¹⁶, Ω₄¹⁶). Then the following restriction applies to maintain orthogonality: if the parent sequence is employed, all the children sequences cannot be used. For equal-rate transmission, all users employ sequences at the final (i.e., L^{th}) iteration. Alternatively, a G×G orthogonal matrix Ω can be constructed based on other methods other than the iterative procedure above, and the restriction that G=2^{L} can be relaxed.

4. The STD sequences are in fact the orthogonal sequences Ω (obtained in step 3) transmitted along a broadened space-time diagonal (defined by the non-zero entries in the corresponding BSTDM). In other words, given a BSTDM, the chips of each sequence are distributed among those time slots (over different antennas), where the corresponding entries in the designated BSTDM are non-zero. The general principle of chip distribution is to have each sequence spread over all entries of a space-time diagonal at least once (not necessarily all entries in the broadened space-time diagonal). This principle is particularly important for multi-rate transmission in which sequences may have different lengths and some of them may have lengths smaller than the total number of entries (i.e., G) in a broadened space-time diagonal. It is assumed these sequence lengths are all multiples of N and divisors of G. According to the above principle, the following matrix shows how the chips (belonging to the sequence fD) are allocated to different time slots (columns) at different antennas (rows),

$$\begin{matrix}\begin{matrix}{D}_{m} ( {Ω}_{i} ) = \\ [ \begin{matrix}{Ω}_{i , 1} {Ω}_{i , N + 1} ⋯ {Ω}_{i , G - N + 1} & 0 & 0 & 0 \\ 0 & {Ω}_{i , 2} {Ω}_{i , N + 2} ⋯ {Ω}_{i , G - N + 2} & 0 & 0 \\ 0 & 0 & ⋰ & 0 \\ 0 & 0 & 0 & {Ω}_{i , N} {Ω}_{i , 2 N} ⋯ {Ω}_{i , G}\end{matrix} ]\end{matrix} & ( 4 )\end{matrix}$$

In (4), Dₘ denotes the distribution of chips among a broadened space-time diagonal. This distribution will be mapped to the m^{th} BSTDM in step 5. When a user transmits at a higher rate (sequence's length is less than G), the same sequence is repeatedly transmitted over the spreading period in order to deliver the target rate. In this case, Ωᵢ is the concatenation of several copies of the original sequence whose length is less than G, such that the total length of Ωᵢ is G (see FIG. 4 for example, where Ω₁=└Ω₁² Ω₁²┘) . For equal-rate transmission, the distributions corresponding to different BSTDMs are all the same. For multi-rate transmission, the distributions can be made different for different BSTDMs, as it depends on the sequence length and the number of users transmitted at a particular data rate.

5. Finally, the set of STD sequences can be constructed by mapping the Dₘ(Ωᵢ) matrix to the m^{th} BSTDM as follows,

S_{(i,m)}=Ω_{BSTD,m}*Dₘ(Ωᵢ)i=1, . . . ,G , m=1, . . . ,N (5)

where * is defined as the product of two block matrices, in which the block-to-block multiplications are calculated on a element-by-element basis (denoted by). (Given two M×N matrices, X=[xᵢⱼ]^{MN}, Y=[yᵢⱼ]^{MN}, then X∘Y=[xᵢⱼyᵢⱼ]^{MN}) For example,

$$[ \begin{matrix}A & B \\ C & D\end{matrix} ] * [ \begin{matrix}E & F \\ G & H\end{matrix} ] = [ \begin{matrix}A ∘ E + B ∘ G & A ∘ F + B ∘ H \\ C ∘ E + D ∘ G & C ∘ F + D ∘ H\end{matrix} ] \qquad ( 6 )$$

In our case, the sub-blocks in φ_{BSTD, m} and Dₘ(Ωᵢ) have dimension 1×G/N Thus, there are in total G N sequences (G sequences for each BSTDM).

6. It is optional that one can perform arbitrary permutation over the columns in S_{(i,m).} This permutation is repeated for each S_{(i,m)}, and a new set of STD sequences are generated.

Example. N=2, G=4

1. Construct two STDMs as follows,

$$\begin{matrix}{Φ}_{STD , 1} = [ \begin{matrix}1 & 0 \\ 0 & 1\end{matrix} ] , & & & {Φ}_{STD , 2} = [ \begin{matrix}0 & 1 \\ 1 & 0\end{matrix} ]\end{matrix} \qquad ( 7 )$$

2. Construct two BSTDMs, as follows,

$$\begin{matrix}{Φ}_{BSTD , 1} = [ \begin{matrix}1 & 1 & 0 & 0 \\ 0 & 0 & 1 & 1\end{matrix} ] , & & & {Φ}_{BSTD , 2} = [ \begin{matrix}0 & 0 & 1 & 1 \\ 1 & 1 & 0 & 0\end{matrix} ]\end{matrix} \qquad ( 8 )$$

3. Construct a 4×4 tree-structured multi-rate matrix,

$$Ω = [ \begin{matrix}1 & 1 & 1 & 1 \\ 1 & 1 & - 1 & - 1 \\ 1 & - 1 & 1 & - 1 \\ 1 & - 1 & - 1 & 1\end{matrix} ] \qquad ( 9 )$$

4. For equal-rate transmission,

$$\begin{matrix}\begin{matrix}{D}_{m} ( {Ω}_{1} ) = [ \begin{matrix}1 & 1 & 0 & 0 \\ 0 & 0 & 1 & 1\end{matrix} ] , & {D}_{m} ( {Ω}_{2} ) = [ \begin{matrix}1 & - 1 & 0 & 0 \\ 0 & 0 & 1 & - 1\end{matrix} ] \\ {D}_{m} ( {Ω}_{3} ) = [ \begin{matrix}1 & 1 & 0 & 0 \\ 0 & 0 & - 1 & - 1\end{matrix} ] , & {D}_{m} ( {Ω}_{4} ) = [ \begin{matrix}1 & - 1 & 0 & 0 \\ 0 & 0 & - 1 & 1\end{matrix} ]\end{matrix} , & m = 1 , 2\end{matrix} \qquad ( 10 )$$

For multi-rate transmission, based on FIG. 3, assume there are 7 users. Six users are transmitting at the normal-rate G=4, while one user is transmitting at double-rate. As there are two STDMs, one can construct Dₘ, m=1,2. Four normal-rate users are assigned sequences Ωᵢ⁴, i=1,2,3,4, for Φ_{BSTD,1} while the other two normal-rate users and one double-rate user are using Ω₃⁴, Ω₄⁴, └Ω₁² Ω₁²┘ (see FIGS. 3 and 4) for Φ_{BSTD,2}, respectively.

$$\begin{matrix}{D}_{1} ( {Ω}_{1}^{4} ) = [ \begin{matrix}1 & 1 & 0 & 0 \\ 0 & 0 & 1 & 1\end{matrix} ] , & {D}_{1} ( {Ω}_{2}^{4} ) = [ \begin{matrix}1 & - 1 & 0 & 0 \\ 0 & 0 & 1 & - 1\end{matrix} ] \\ {D}_{1} ( {Ω}_{3}^{4} ) = [ \begin{matrix}1 & 1 & 0 & 0 \\ 0 & 0 & - 1 & - 1\end{matrix} ] , & {D}_{1} ( {Ω}_{4}^{4} ) = [ \begin{matrix}1 & - 1 & 0 & 0 \\ 0 & 0 & - 1 & 1\end{matrix} ] \\ {D}_{2} ( [ {Ω}_{1}^{2} {Ω}_{1}^{2} ] ) = [ \begin{matrix}1 & 1 & 0 & 0 \\ 0 & 0 & 1 & 1\end{matrix} ] , & {D}_{2} ( {Ω}_{3}^{4} ) = [ \begin{matrix}1 & 1 & 0 & 0 \\ 0 & 0 & - 1 & - 1\end{matrix} ] \\ {D}_{2} ( {Ω}_{4}^{4} ) = [ \begin{matrix}1 & - 1 & 0 & 0 \\ 0 & 0 & - 1 & 1\end{matrix} ] & \end{matrix} \qquad ( 11 )$$

5. Construct the set of STD sequences,

Equal-rate

$${S}_{1 , 1} = [ \begin{matrix}1 & 1 & 0 & 0 \\ 0 & 0 & 1 & 1\end{matrix} ] , {S}_{1 , 2} = [ \begin{matrix}1 & - 1 & 0 & 0 \\ 0 & 0 & 1 & - 1\end{matrix} ] \\ {S}_{1 , 3} = [ \begin{matrix}1 & 1 & 0 & 0 \\ 0 & 0 & - 1 & - 1\end{matrix} ] , {S}_{1 , 4} = [ \begin{matrix}1 & - 1 & 0 & 0 \\ 0 & 0 & - 1 & 1\end{matrix} ] \\ {S}_{2 , 1} = [ \begin{matrix}0 & 0 & 1 & 1 \\ 1 & 1 & 0 & 0\end{matrix} ] , {S}_{2 , 2} = [ \begin{matrix}0 & 0 & 1 & - 1 \\ 1 & - 1 & 0 & 0\end{matrix} ] \\ {S}_{2 , 3} = [ \begin{matrix}0 & 0 & 1 & 1 \\ - 1 & - 1 & 0 & 0\end{matrix} ] , {S}_{2 , 4} = [ \begin{matrix}0 & 0 & 1 & - 1 \\ - 1 & 1 & 0 & 0\end{matrix} ] \qquad ( 12 )$$

Multi-rate: the first four normal-rate users are using S_{(1,1)}, S_{(1,2)}, S_{(1,3)}, S_{(1,4)} listed as above, while the last three users are stated as follows,

$${S}_{2 , 1} = ( [ \begin{matrix}0 & 0 & 1 & 0 \\ 1 & 0 & 0 & 0\end{matrix} ] [ \begin{matrix}0 & 0 & 0 & 1 \\ 0 & 1 & 0 & 0\end{matrix} ] ) \\ {S}_{2 , 3} = [ \begin{matrix}0 & 0 & 1 & 1 \\ - 1 & - 1 & 0 & 0\end{matrix} ] , {S}_{2 , 4} = [ \begin{matrix}0 & 0 & 1 & - 1 \\ - 1 & 1 & 0 & 0\end{matrix} ] \qquad ( 13 )$$

IV. The Encoders

In general, the SISO encoder can be of any type of code that is employed for single-antenna system, e.g. binary convolutional code. For a binary code, C with rate k/n, during the designated transmission interval, a block of k binary information symbols would enter the encoder, which produces a block of n binary code symbols.

V. The Interleavers (Permutations)

The function of each interleaver is to perform permutations over a block of code symbols delivered by the encoder. In the following, for illustration purpose, it is assumed that the coding schemes are binary. Denote the operation of interleaving (i.e., permutation) as, the original binary code as C□(with rate k/n) and the resulting binary code as (C). The de-interleaving operation is defined likewise as ⁻¹. Two types of interleavers are proposed in SSSMA, (1) mutually optimal interleavers (equal-rate transmission), (2) random-permutation interleavers (equal-rate or multi-rate transmission):

1. For the first type of interleavers, the following definition is required. Let C′=C (C) be the intersection between the original code and the new code. Define the following [2],

Cₒₚₜᵢₘₐₗ interleaver: The interleaver is Cₒₚₜᵢₘₐₗ if the dimension of C′ is as follows,

dim(C′)=k−min{k,n−k}(14)

With the above definition, the set of mutually optimal interleavers employed in SSSMA can be defined as follows,

Mutually Cₒₚₜᵢₘₐₗ interleavers: A set of user-unique interleavers ᵢ, i=1,2, . . . ,K is said to be mutually optimal if ᵢ⁻¹ⱼ is Cₒₚₜᵢₘₐₗ for any pair of i, j, i j.

2. For the second type of interleavers, each interleaver is uniquely, and randomly chosen from the permutation {1,2, . . . ,nᵢ}, where nᵢ is the block-length of the i^{th} user's codeword. Once these set of permutations are chosen, they are fixed and used in the SSSMA system over a designated period of time. It is optional that after this period of time elapses, another set of distinct random permutations are chosen for the next period and so on.

Prior to entering the multiplexer, the outputs from each interleaver are subject to modulation. Two examples are BPSK and QPSK modulations, which are defined as follows,

BPSK mode: The output binary code symbol from each interleaver is BPSK modulated as follows,

{1,0} [symbol] {α,−α} (15)

where α is a scalar constant.

QPSK mode: Every two output binary code symbols from each interleaver is QPSK modulated via Gray mapping as follows,

{(1,1),(1,0),(0,1),(0,0)} [symbol] {(α, α),(α, −α),(−α, α),(−α, −α)}(16)

VI. Power Allocation

In SSSMA, the signals from different users may be allocated different power levels, according to the quality of service (QoS) requirements associated with different users, which reside in a multi-cell (cellular) environment. One important requirement is to maintain the probability of detection error at a certain level, depending on the applications and services delivered to a user. The probability of detection error is a function of the type of the receiver algorithm employed, the power levels of the same-cell and neighboring-cell users received, and the background noise level. The ideal strategy is to perform a global power optimization taking into account all these effects, subject to the power constraint over each base station transmitter. Yet, there exists various optimization criteria, such as minimizing the transmitted power or the outage probability. Due to the widespread use of these two criteria, they are stated as follows for illustration begin, the following notation are needed,

Pₘ—total transmission power at the m^{th} base station.

\overline{Pₘ}—the maximum available power at the m^{th} base station.

P_{tx,m,i}—desired signal power transmitted to the i^{th} user in the m^{th} cell.

P_{rx,m,i}—desired signal power received by the i^{th} user in the m^{th} cell.

P_{(m,i),(n,j)}—interfering power (due to the j^{th} user in the n^{th} cell) received by the i^{th} user in the m^{th} cell.

η_{rx,m,i}—background noise power received by the i^{th} user in the m^{th} cell.

B—number of cells in a multi-cell environment.

φ_{m,i}—the maximum probability of detection error that can be tolerated by the i^{th} user in the m^{th} cell

1. Minimize the Transmitted Power Levels

min Pₘ, m=1, . . . ,B

subject to: P_{fe}=f(η_{rx,m,i}, P_{rx,m,i}, P_{(m,i)(n,j}|n=1, . . . ,B, n≠m, ∀j)≦φ_{m,i}m=1, . . . ,B, i=1, . . . , Kₘ (17)

where Pₑ is the probability of detection error, which is a function of the received power of the desired user, the interference power received by the desired user, and the background noise level.

2. Minimize the Outage Probability,

min Pr(Pₘ>\overline{Pₘ}), m=1, . . . ,B

subject to: Pₑ=f(η_{rx,m,i}, P_{rx,m,i} ,P_{(m,i),(n,j)}|n=1, . . . , B, n≠m, ∀j)≦φ_{m,i} m=1, . . . ,B, i=1, . . . , Kₘ (18)

where Pr(Pₘ>\overline{Pₘ}) is the probability that the required total power exceeds the total available power at the m^{th} base station.

Due to the complexity of the above optimization problems, it is usually common to adjust the power levels according to the desired received signal-to-interference-plus-noise ratio (SINR), rather than the Pₑ. Normally, the received SINR at a specific user's terminal is a function of the link gain (which is based on the distance from the base station, and other fading effects such as shadowing), the intracell and intercell interference from other users.

Below is the general expression of the SINR for the i^{th} user's terminal in the m^{th} cell,

$${Γ}_{m , i} = \frac{{P}_{rx , m , i}}{{I}_{m} + k \cdot {\sum }_{n \neq m}^{B} {I}_{n} + {η}_{rx , m , i}} \qquad ( 19 )$$

where P_{rx,m,i,} is the signal power received at the i^{th} terminal in the i^{th} cell and k is some constant. The interference power of neighboring cells are denoted as Iₙ, n=1, . . . , B, n m and the intra-cell interference is given by,

$${I}_{m} = {\sum }_{j = 1 , j \neq i}^{{K}_{m}} {α}_{j} {P}_{rx , m , j} \qquad ( 20 )$$

where αⱼ, j=1, . . . ,Kₘ are a set of weights which determine the contributions of the interfering power of the same cell users to the desired user. In many cases, they are difficult to be determined, as they may depend on the type of receivers employed and also the instantaneous power levels of the same-cell users. Furthermore, the probability of detection error associated with a particular type of receiver may not be a function of the SINR directly but the variables appeared in the SINR expression.

To simplify the power allocation problem in SSSMA, one can assume the use of multiuser detector and decoding (e.g. iterative joint detection-decoding, TURBO processing), such that the intracell interference can be ignored as they become useful signals in the joint detection at the desired user's terminal. And the SINR becomes,

$$\begin{matrix}{Γ}_{m , i} = \frac{{P}_{rx , m , i}}{k \cdot {\sum }_{n \neq m}^{B} {I}_{n} + {η}_{rx , m , i}} \\ = \frac{{P}_{rx , m , i} {G}_{m , ( m , i )}}{k \cdot {\sum }_{n \neq m}^{B} {\sum }_{k = 1}^{{K}_{n}} {P}_{tx , n , k} {G}_{n , ( m , i )} + {η}_{rx , m , i}}\end{matrix} \qquad ( 21 )$$

where G_{n,(m,i)} is the link gain from the nth base station to the n^{th} user in the m^{th} cell, Kₙ is the number of users in the nth cell. The transmitted power, P_{tx m,i}, is the total power assigned to the i^{th} user over all transmit antennas at the base station.

With equation (21), one can utilize various power control schemes according to specific objectives and assumptions. For illustration purpose, the global power optimization algorithm is outlined below. The objective of the algorithm is to attain the achievable SINR requirement of all the terminals. The algorithm is described as follows,

1. Define P=[P_{tx,1,1}P_{tx,1,2} . . . P_{tx,2,k}_{₁}P_{tx,2,1}P_{tx,2,K}_{₂} . . . P_{tx,B,K}_{_{B}}]^{T} and Z is the link gain matrix, which can be expressed as a block-matrix,

$$Z = [ \begin{matrix}{Z}^{( 11 )} & {Z}^{( 12 )} & ⋯ & {Z}^{( 1 B )} \\ {Z}^{( 21 )} & {Z}^{( 22 )} & ⋯ & {Z}^{( 2 B )} \\ ⋮ & ⋮ & ⋰ & ⋮ \\ {Z}^{( B1 )} & {Z}^{( B2 )} & ⋯ & {Z}^{( BB )}\end{matrix} ] \qquad ( 22 )$$

where the entries of Z^{(mn)} are given by,

$${Z}_{ij}^{( mn )} = \{ \begin{matrix}\frac{{G}_{n , ( m , i )}}{{G}_{m , ( m , i )}} & \text{if} m \neq n \\ 1 & \text{if} m = n , i = j \\ 0 & \text{if} m = n , i \neq j\end{matrix} \qquad ( 23 )$$

Solve for the minimum real A such that the inequality holds,

λP≧ZP (24)

which has solutions for P 0 is λ=λ*. And the achievable SINR level (γ*) is given by,

$${γ}^{*} = max \{ γ \vert ∃ P \geq 0 \text{:} {Γ}_{m , i} \geq γ , ∀ i \} = \frac{1}{k ( {λ}^{*} - 1 )} \qquad ( 25 )$$

Single-Cell system

In SSSMA, the users' receivers may exploit the spatial interference to their own advantage. The existence of spatial interference is due to principle of SSSMA, which allows users to co-exist over the space domain in each MIMO radio link. This is forbidden in conventional multiple access system which avoids interference by allocating users over orthogonal channels. With proper power allocation, SSSMA will greatly benefit from this type of exploitation of spatial interference.

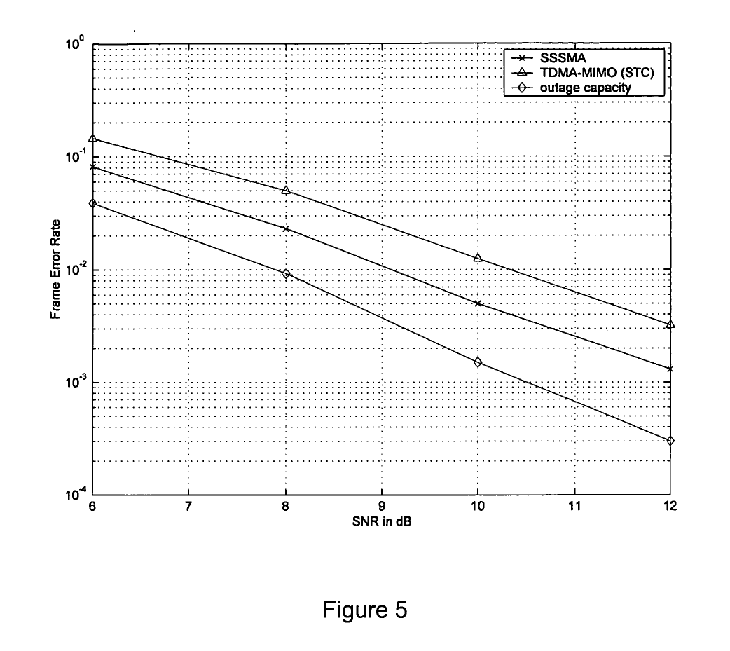

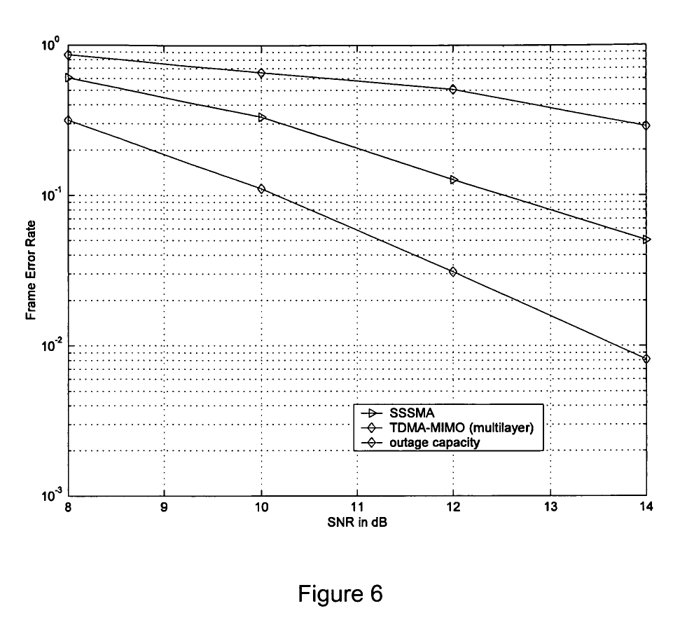

To illustrate the unique advantage offered by SSSMA, when power allocation is applied, we use the single-cell system as our system model. In the single-cell system, no inter-cell interference is present. Therefore, the power allocation is based on balancing the SNR (eqn. 21 where only the noise term remains). To simplify the process, we assume that the SNR adopted is a coarse SNR, which means that we only attempt to compensate the effect of large-scale attenuation such as path-loss/shadowing-loss, while multi-path fading is not included as it is harder to be tracked. Furthermore, assume that all users demand the same quality of service, which in turn implies that they should receive the same level of power associated with their desired signals. FIG. 5 and FIG. 6 contain the simulation results. The list of parameters and channel models used in the simulations are discussed as follows.

First, we consider no power allocation. A small-scale environment such as wireless LAN is considered (with multi-path fading only). In SSSMA, we use the 32-state rate-½ convolutional code (octal generators (53, 75)) for each user. In the simulations, a block of 255 information symbols is generated for each user-channel. The output code symbols are interleaved, then modulated based on QPSK with Gray mapping. The set of interleavers are randomly and uniformly chosen from the permutation {1, 2, . . . , 512}. With N=2, G=128, the spectral efficiency is 2 bps/Hz. FIG. 5 depicts the results in terms of average outage probability under independent fading. With the same per-user transmit energy and bandwidth constraint, we include the performance of a TDMA-MIMO using 32-state space-time-code (STC-32) with the same data rate (2 bps/Hz). Note that STC schemes can be employed in any orthogonal TDMA/FDMA/CDMA-MIMO system, thereby allowing a fair comparison with SSSMA. The SSSMA system delivers the best performance in this particular scenario.

Next, in FIG. 6, a power-controlled large-scale system or MAN (with path-loss, shadowing and multi-path fading) is considered. Power control is used to compensate the path-loss and shadowing loss only. We consider N=2, G=2 and four users. The users are uniformly distributed within a distance of 10 m to 210 m from the base station in a single-cell. The path-loss exponent and the standard deviation of log-normal shadowing are taken to be 3.7 and 6 dB, respectively. Unlike the LAN scenario, a higher spectral efficiency is attempted by employing a rate ⅔ bit-interleaved-coded-modulation scheme for each user with a 64-states generator (236,155,337). Using 8-PSK modulation, the resulting spectral efficiency is 4 bps/Hz. For illustration, we include the results of a TDMA multi-layered MIMO scheme. The performance is very poor. It is clear that SSSMA outperforms the conventional multiple access schemes significantly in a power-controlled cellular/MAN network, especially for heavily-loaded system with high spectral efficiency. We can then conclude that our simulation results have justified the use of MIMO techniques and SSSMA in future wireless technologies, which require a significant growth in the spectral efficiency.

Other System Applications

In the following we describe various other system applications for which the current SSSMA invention may be utilized. The present invention combines spread spectrum code division multiple access techniques (CDMA) with transmission over multiple antennas. In the context of the evolution of cellular networks there has been a tendency for the research and standardization communities to move away from spread spectrum techniques that were predominant in third generation systems (3 G) to non-spread spectrum techniques such as orthogonal frequency division multiplexing (OFDM). Part of the reason for the emphasis of these non-spread spectrum techniques is the realization that spread spectrum is difficult to implement at very high data rates and extremely high chip rates. Another current trend is for the wireless industry to move to networks that are deployed in an ad-hoc manner and are self-configurable. These network architectures favor the use of spread spectrum techniques that are robust against interference. We also recognize that in the future novel receiver design techniques such as the implementation of various spread spectrum processing algorithms including the basic function of dispreading will find simpler implementations include the use of analog processing circuits. Within this context we foresee a role for spread spectrum techniques in the evolution of future wireless standards and consequently the application of the present invention in MIMO based spread spectrum point-to-multipoint transmission systems of the future.

Another area of emerging importance is that of ultra wide-band transmission (UWB) systems. The FCC has recently allocated spectrum in the range 3-8 GHz (approximate band) for these types of systems. In these types of systems a very wide bandwidth signal (typically with a bandwidth greater than 500 MHz) is transmitted. It is foreseen that with future receiver architectures these systems will also employ MIMO transmission techniques. The current invention (SSSMA) is a candidate modulation scheme for these proposed systems of the future.

One aspect of the above mentioned MIMO systems is that the very wide bandwidth allocated to the UWB system may be used in a manner where the transmitted signal uses a portion of the UWB allocated spectrum that is adaptively selected to avoid interference in a specific receiver location. The current invention (SSSMA) is a candidate modulation scheme for these adaptive systems.

In another realization of UWB systems we may synthesize a signal with a very large bandwidth but non-contiguous spectrum. That is, the synthesized (transmitted) UWB signal consists of a number of separate non-overlapping sub-bands with smaller bandwidths. The SSSMA scheme disclosed here could be implemented as the modulation scheme in each of the sub-bands of said transmission scheme. In these schemes there would be a given set of parallel channels created from sets of parallel channels within each sub-band using the disclosed SSSMA scheme. The signals from the different users may be mapped in such a way that each signal resides in a given sub-band, or alternatively each user signal may be broken down into a number of sub-streams that are transmitted over different channels in the different sub-bands.

The disclosed SSSMA scheme is a natural candidate modulation scheme for an enhanced version of a third generation (3 G) system with an appropriate modification of the air interface to permit the use of MIMO techniques. In the current versions of the WCDMA and CDMA2000 3G standards the forward link utilizes a form of orthogonal CDMA for the continuous transmission of multiplexed signals intended for different users within a cell. The current invention would introduce a mode of transmission in the forward link where the different channels in 3 G, that correspond to the different Walsh functions, are mapped to the different (users) channels contained in the SSSMA invention disclosed here.

The current 3G standards also contain a time division duplexing (TDD) mode. The SSSMA invention can also be applied as the modulation scheme of a future enhancement of the TDD mode to enable the use of MIMO techniques.

In terms of network architecture we foresee the evolution to a two level architecture where all the nodes in the network including the infrastructure nodes (currently referred to as base stations, or access points) will evolve to have a capability for mobility or at least portability. The network would consist of two classes of nodes, where both classes have capability for mobility. Class 1 would consist of nodes with a lower degree of mobility and higher link capacity that would act as a backbone network to provide network access to the nodes of class 2, which have lower transmission capacity and higher mobility. The links interconnecting class 1 nodes would carry multiplexed traffic from the class 2 nodes. The SSSMA scheme disclosed here may be use as the modulation scheme in such a two-level wireless network, for both the interconnection of the class 1 nodes—the mobile access points, or base stations, and the connection of class 2 nodes to the class 1 node access points, i.e. an access cluster of terminals for a given class 1 node.

In the evolution of wireless networks we also foresee the evolution of the current ad-hoc networks referred to as WiFi, or the different versions of the IEEE802.11 standards. The proposed SSSMA is a candidate modulation scheme for the evolution of this standard to a future version that incorporates MIMO techniques.

Currently there are various wireless standards activities for broadband wireless transmission. These include the IEEE802.15 (various versions or subgroups), IEEE802.16 (also different versions for different environments), and IEEE802.20. The disclosed SSSMA scheme is a candidate modulation scheme for future evolutions of these standards.

As used herein, the terms “comprises”, “comprising”, “including” and “includes” are to be construed as being inclusive and open ended, and not exclusive. Specifically, when used in this specification including claims, the terms “comprises”, “comprising”, “including” and “includes” and variations thereof mean the specified features, steps or components are included. These terms are not to be interpreted to exclude the presence of other features, steps or components.

The foregoing description of the preferred embodiments of the invention has been presented to illustrate the principles of the invention and not to limit the invention to the particular embodiment illustrated. It is intended that the scope of the invention be defined by all of the embodiments encompassed within the following claims and their equivalents.

### REFERENCES

[1] F. Adachi, M. Sawahashi and K. Okawa, “Tree-structured generation of orthogonal spreading codes with different lengths for forward link of DS-CDMA mobile radio”, Electronics Letters, vol. 33, January 1997, pp. 27-28.

[2] A. Tarable, G. Montorsi and S. Benedetto, “Analysis and design of interleavers for CDMA systems”, IEEE Communication Letters, vol. 5, October 2001, pp. 420-422.

[3] B. K. Ng and E. S. Sousa, “Space-time spreading multilayered CDMA systems”, Proc. IEEE Globecom, November 2000.

[4] B. K. Ng and E. S. Sousa, “A novel spread space-spectrum multiple access for the forward link”, WCNC, March 2002

[5] B. Hassibi and B. M. Hochwald, “High-rate codes that are linear in space and time”, IEEE Transactions on Information Theory, vol. 48, July 2002, pp.1804-1824.

Therefore what is claimed is:

1. A spread space spectrum multiple access method for a forward link in a wireless multi-antenna system serving multiple users, the method comprising the steps of:
multiplexing signals from different users at a base station transmitter having multiple antenna elements, modulating different users' signal streams that are of different/same data rate using a set of multi-rate/equal-rate space-time diagonal (STD) spreading sequences, each user being assigned a unique STD sequence, which modulates one code/information symbol over the spreading period, said STD sequences spanning across the spreading period over different transmitting antennas; and
transmitting the multiplexed signals through the multiple antenna elements at the base station wherein signals from the different users are transmitted simultaneously, a signal from each user being transmitted as a sequence of channel code symbols, where each such symbol is a sequence of direct sequence spread spectrum chips, the sequence of chips (block of chips) is sub-divided into a set of sub-blocks, where each sub-block is transmitted sequentially over a different antenna.

2. The method according to claim 1 wherein each STD sequence is represented by a matrix, where each column has one non-zero value, and wherein elements along a given row represent the chips transmitted on the antenna corresponding to that row.

3. The method according to claim 2 wherein each STD sequence is constructed by i) defining N, G to be the number of transmitting antennas and the processing gain (or spreading factor) for the lowest rate user, respectively, each STD sequence being represented by a N×G matrix in which the rows and columns represent the antenna (space) domain and the time domain, respectively,
ii) defining a set of N broadened space-time diagonals over the space-time grid,
iii) for equal-rate transmission, construct a G by G orthogonal sequences matrix, or, for multi-rate transmission, construct a G by G tree-structured sequences matrix, comprised of orthogonal sequences with different lengths, and
iv) distribute chips of the orthogonal sequences constructed in step iii) along a broadened space-time diagonal, the distribution allowing each sequence to have access to all transmitting antennas (occur at different time instants over the spreading period), repeat for all N diagonals obtained in step ii).

4. The method according to claim 3 wherein the signals from different users are allocated different power levels, according to a quality of service (QoS) requirements including an error-rate performance, associated with different users.

5. The method according to claim 1 including a set of user-specific interleavers, each interleaver performing permutation over a block of code symbols that are delivered by the corresponding user's encoder, wherein each interleaver is uniquely, and randomly chosen from the permutation {1,2, . . . nᵢ}, where ni is the block-length of the i^{th} user's codeword, upon selection of a set of permutations, they are fixed and used in the system over a designated period of time, and wherein after this period of time elapses, another set of distinct random permutations are chosen for the next period.

6. A forward link apparatus in a wireless multi-antenna system serving multiple users, comprising:
a base station transmitter with receivers at users' terminals including multiple antenna elements;
multiplexer means for multiplexing signals from different users are combined and transmitted through the multiple antenna elements at the base station, processing means for producing a set of multi-rate/equal-rate space-time diagonal (STD) spreading sequences for modulating different users' signal streams that are of different/same data rate, each user being assigned a unique STD sequence, which modulates one code/information symbol over the spreading period, said STD sequences spanning across the spreading period over different transmitting antennas; and
wherein signals from the different users are transmitted simultaneously, a signal from each user is transmitted as a sequence of channel code symbols, where each such symbol is a sequence of direct sequence spread spectrum chips, the sequence of chips (block of chips) is sub-divided into a set of sub-blocks, where each sub-block is transmitted sequentially over a different antenna.

7. The apparatus according to claim 6 wherein each STD sequence is represented by a matrix, where each column has one non-zero value, and wherein elements along a given row represent the chips transmitted on the antenna corresponding to that row.

8. The apparatus according to claim 7 wherein each STD sequence is constructed by
i) defining N, G to be the number of transmitting antennas and the processing gain (or spreading factor) for the lowest rate user, respectively, each STD sequence being represented by a N×G matrix in which the rows and columns represent the antenna (space) domain and the time domain, respectively,
ii) defining a set of N broadened space-time diagonals over the space-time grid,
iii) for equal-rate transmission, construct a G by G orthogonal sequences matrix, or, for multi-rate transmission, construct a G by G tree-structured sequences matrix, comprised of orthogonal sequences with different lengths, and
iv) distribute chips of the orthogonal sequences constructed in step iii) along a broadened space-time diagonal, the distribution allowing each sequence to have access to all transmitting antennas (occur at different time instants over the spreading period), repeat for all N diagonals obtained in step ii).

9. The apparatus according to claim 8 wherein the signals from different users are allocated different power levels, according to a quality of service (QoS) requirements including an error-rate performance, associated with different users.

10. The apparatus according to claim 6 including a set of user-specific interleavers, each interleaver performing permutation over a block of code symbols that are delivered by the corresponding user's encoder, wherein each interleaver is uniquely, and randomly chosen from the permutation {1,2, . . . nᵢ}, where nᵢ is the block-length of the i^{th} users codeword, upon selection of a set of permutations, they are fixed and used in the system over a designated period of time, and wherein after this period of time elapses, another set of distinct random permutations are chosen for the next period.

11. The method according to claim 6 including global power optimization including
defining P=[P_{tx,1,1} P_{tx,1,2} . . . P_{tx,1,K}_{₁} P_{tx,2,1} O_{tx,2,K}₂ . . . P_{tx.B,K}_{_{B}}]^{T} and Z is the link gain matrix, which can be expressed as a block-matrix,
$$Z = [ \begin{matrix}{Z}^{( 11 )} & {Z}^{( 12 )} & ⋯ & {Z}^{( 1 B )} \\ {Z}^{( 21 )} & {Z}^{( 22 )} & ⋯ & {Z}^{( 2 B )} \\ ⋮ & ⋮ & ⋰ & ⋮ \\ {Z}^{( B1 )} & {Z}^{( B2 )} & ⋯ & {Z}^{( BB )}\end{matrix} ]$$
where the entries of Z^{(mn)} are given by,
$${Z}_{ij}^{( mn )} = \{ \begin{matrix}\frac{{G}_{n , ( m , i )}}{{G}_{m , ( m , i )}} & \text{if} m \neq n \\ 1 & \text{if} m = n , i = j \\ 0 & \text{if} m = n , i \neq j\end{matrix}$$
solving for minimum real λ such that an inequality holds,
λP≧ZP
which has solutions for P 0 is λ=λ*
and an achievable SINR level (γ*) is given by,
$${γ}^{*} = max \{ γ \vert ∃ P \geq 0 \text{:} {Γ}_{m , i} \geq γ , ∀ i \} = \frac{1}{k ( {λ}^{*} - 1 )}$$

12. The apparatus according to claim 6 including set of user-specific interleavers, wherein each interleaver is to perform permutation over a block of code symbols that are delivered by the corresponding user's encoder, each interleaver being uniquely, and randomly chosen from the permutation {1,2, . . . , nᵢ}, where nᵢ is the block-length of the i^{th} user's codeword, and wherein once this set of permutations are chosen, they are fixed and used in the apparatus over a designated period of time, and wherein after this period of time elapses, another set of distinct random permutations are chosen for the next period and so on.
